(19) United States
(12) Patent Application Publication
(10) Pub. No.: US 2012/0198986 A1
(43) Pub. Date: Aug. 9, 2012

(54) Method/Apparatus for training absolute pitch, electronic musical instrument and sound source processing apparatus

(76) Inventor: Young Il Chung, Daegu (KR)

(21) Appl. No.: 13/502,793

(22) PCT Filed: Oct. 7, 2010
(86) PCT No.: PCT/KR2010/006860

§ 371 Date: Apr. 19, 2012

(30) Foreign Application Priority Data
Oct. 28, 2009 (KR) 10-2009-0102918

(51) Int. Cl. G10H 7/00

(52) U.S. Cl. 84/622

(57) ABSTRACT

The embodiments of the present invention relate to a method and an apparatus for training an absolute pitch, to an electronic musical instrument, and to a sound source processing apparatus. According to one embodiment of the present invention, an absolute pitch training apparatus is provided, comprising: an output request input unit for taking, as an input, an output request for a specific sound; an overtone output unit for outputting an overtone, the number of vibrations of which is greater than the basic number of vibrations for a specific sound; and a compound tone output unit for outputting a compound tone in which a fundamental sound, having a basic number of vibrations, and an overtone for a specific sound are mixed. According to one embodiment of the present invention, an absolute pitch training method for training an absolute pitch is proposed, enabling persons necessarily requiring an absolute pitch to train so as to achieve an absolute pitch.

### CROSS-REFERENCE TO RELATED APPLICATION

This application claims priority from Korean Patent Application No. 10-2009-0102918, filed on Oct. 28, 2009 in the Korean Intellectual Property Office, the disclosure of which is incorporated herein by reference, in accordance with Article 119(a) of the US Patent Act (35 U.S.C §119(a)). This application claims priority by the same reason as above with respect to countries other than the United State of America, the disclosure of which is incorporated herein by reference.

### TECHNICAL FIELD

The present invention relates to a method and apparatus for training absolute pitch, an electronic musical instrument and a sound source processing apparatus, and more particularly, to a method and apparatus for training an absolute pitch, an electronic musical instrument and a sound source processing apparatus which provides an absolute pitch training method for training an absolute pitch and enables persons necessarily requiring an absolute pitch to train so as to achieve an absolute pitch.

### BACKGROUND ART

Absolute pitch means the auditory ability to promptly identify inherent pitch of a certain sound (generally, musical sound). Most people do not have such absolute pitch, and the persons who study music, engage in work relating to work or wish to develop musicality definitely need the absolute pitch.

To identify the pitch of the sound, a listener should accurately distinguish a fundamental sound from a compound tone in which the fundamental sound having a basic number of vibrations and a overtone having the greater number of vibrations than the basic number of vibrations are mixed, and should recognize that focus is given to which pitch. Through the foregoing process, the listener may determine the inherent pitch of each sound. The focus is given to a lower pitch for a low sound, and to a higher pitch for a higher sound. Giving focus means the sound in a frequency band is large and clear.

However, due to the reason that most sounds in nature are compound tones in which the fundamental sound having a basic number of vibrations and an overtone having the greater number of vibrations than the basic number of vibrations are mixed, normal people fail to focus on the fundamental sound necessary for identifying the inherent pitch of the sound in the compound tone and thus do not have the absolute pitch.

Accordingly, an absolute pitch training method for training an absolute pitch is needed for people who study music, are engaged in work relating to music or wish to improve musicality. However, the method and apparatus for training the absolute pitch has not been developed.

### DISCLOSURE

### Technical Problem

The present invention has been made to solve the problems and it is an object of the present invention to provide an absolute pitch training method for training an absolute pitch to thereby enable persons necessarily requiring an absolute pitch to train so as to achieve an absolute pitch.

### Technical Solution

According to an exemplary embodiment of the present invention, an absolute pitch training apparatus comprises an output request input unit for taking, as an input, an output request for a specific sound; an overtone output unit for outputting an overtone, the number of vibrations of which is greater than the basic number of vibrations for the specific sound; and a compound tone output unit for outputting a compound tone in which a fundamental sound, having a basic number of vibrations, and the overtone for the specific sound are mixed.

According to another exemplary embodiment of the present invention, an absolute pitch training method comprising: taking, as an input, an output request for a specific sound; outputting an overtone for outputting an overtone, the number of vibrations of which is greater than a basic number of vibrations for the specific sound; and outputting a compound tone for outputting a compound tone in which a fundamental sound having a basic number of vibrations and the overtone for the specific sound are mixed.

According to another exemplary embodiment of the present invention, an electronic musical instrument comprising: a musical instrument mode input unit for receiving an input for a musical instrument mode for designating a specific musical instrument of at least one musical instrument; an output request input unit for taking, as an input, an output request for a specific sound; an overtone output unit for outputting an overtone the number of vibrations of which is greater than a basic number of vibrations for the specific sound as a tone of the specific musical instrument; and a compound tone output unit for outputting a compound tone in which a fundamental sound having a basic number of vibrations and the overtone for the specific sound are mixed, as a tone of the specific musical instrument.

According to another exemplary embodiment of the present invention, a sound source processing apparatus comprising: a sound source storage unit for storing therein a sound source; a sound source separator for separating a fundamental sound having a basic number of vibrations and an overtone the number of vibrations of which is greater than the basic number of vibrations from the stored sound source; and a sound source output unit for outputting at least one of the fundamental sound, the overtone and the compound tone in which the fundamental sound and the overtone are mixed.

### Advantageous Effect

As described above, according to one embodiment of the present invention, an absolute pitch training method for training absolute pitch is proposed, enabling persons necessarily requiring an absolute pitch to train so as to achieve an absolute pitch.

### BRIEF DESCRIPTION OF DRAWINGS

FIG. 1 is a block diagram of an absolute pitch training apparatus according to an exemplary embodiment of the present invention.

FIG. 2 is a flowchart of an absolute pitch training method according to another exemplary embodiment of the present invention.

FIG. 3 is a block diagram of an electronic musical instrument according to another exemplary embodiment of the present invention.

FIG. 4 is a block diagram of a sound source processing apparatus according to another exemplary embodiment of the present invention.

### BEST MODE

Hereinafter, exemplary embodiments of the present invention will be described in detail with reference to accompanying drawings. In assigning reference numerals to elements in each drawing, it shall be noted that like elements have like reference numerals as much as possible even if illustrated in different drawings. In describing the present invention, detailed description of relevant known configuration or function will be omitted if it is determined that such description may make the substance of the present invention unclear.

In describing elements of the present invention, terms such as first, second A, B, (a), (b) and others may be used. Such terms are used only for purposes of distinguishing an element from other element, but do not limit the substance of the element, sequence or order. If it is stated that a certain element is “connected”, “coupled” or “contacts” to another element, it should be understand that the certain element may be directly connected or coupled to the another element, but also another element may be “connected”, “coupled” or “contacts” to such elements.

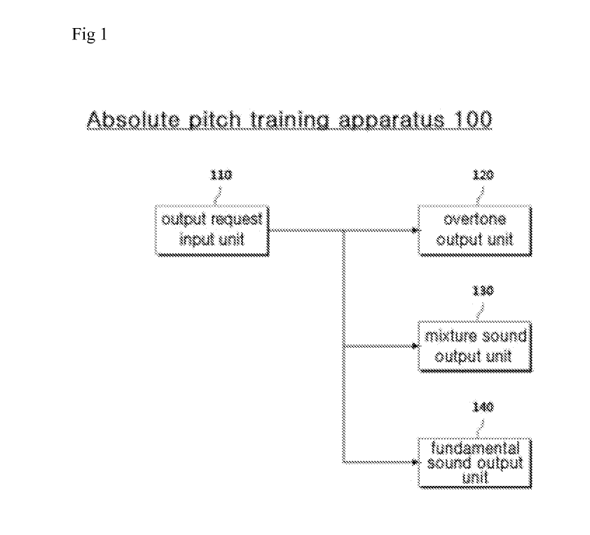

FIG. 1 is a block diagram of an absolute pitch training apparatus 100 according to an exemplary embodiment of the present invention.

Referring to FIG. 1, the absolute pitch training apparatus 100 according to the exemplary embodiment of the present invention includes an output request input unit 110 for taking, as an input, an output request for a specific sound; an overtone output unit 120 for outputting an overtone, the number of vibrations of which is greater than the basic number of vibrations for a specific sound which has been requested to be output; and a compound tone output unit 130 for outputting a compound tone in which a fundamental sound having a basic number of vibrations for the specific sound which has been requested to be output, and an overtone for the specific sound having the greater number of vibrations than the basic number of vibrations for a specific sound which has been requested to be output.

Referring to FIG. 1, the absolute pitch training apparatus 100 according to the exemplary embodiment of the present invention may further include a fundamental sound output unit 140 for outputting a fundamental sound having the basic number of vibrations for the specific sound which has been requested to be output.

As described above, the absolute pitch training apparatus 100 according to the exemplary embodiment of the present invention is an apparatus for training an absolute pitch which means the auditory ability to promptly identify inherent pitch of a specific sound (generally, musical sound). That is, the absolute pitch training apparatus 100 according to the exemplary embodiment of the present invention enables a user to accurately identify the fundamental sound having the basic number of vibrations after listing to a general sound which is a compound tone of the fundamental sound having the basic number of vibrations and an overtone having the greater number of vibrations than the basic number of vibrations and identify inherent pitch of the sound to thereby train an absolute pitch.

The fundamental sound, which is also called fundamental tone, has the smallest number of vibrations, i.e., has the basic number of vibrations and occurs when the entire object vibrates. The overtone on the other hand has the greater number of vibrations than the number of vibrations of the fundamental sound (i.e., basic number of vibrations). The number of vibrations of the overtone is two or more integer values of the number of vibrations of the fundamental sound (i.e., basic number of vibrations) and occurs when a part of an object vibrates. The sound in which the fundamental sound and the overtone are mixed is called a compound tone which is a typical sound existing in nature.

As the sound existing in daily life or music is the compound tone in which the fundamental sound and the overtone are mixed, normal users who do not have an absolute pitch are not capable of focusing on the fundamental sound necessary for identifying an inherent pitch of sound, failing to have the absolute pitch. That is, users should recognize the fundamental sound to have the absolute pitch, but the overtone obstructs such recognition of the fundamental sound so that they fail to have the absolute pitch.

Recognition of the fundamental sound means the state in which the fundamental sound is heard. Focusing on the fundamental sound means that a user hears the fundamental sound loud and clear.

A method for training absolute pitch which is based on hearing only the fundamental sound is easy for a trainee to recognize the fundamental sound during training as he/she hears a sound including only the fundamental sound. However, if the trainee hears a compound tone in which the fundamental sound and the overtone are mixed, he/she may not recognize the fundamental sound. Also, as the sound has no overtone, it is hard to know whether the trainee has focused on the fundamental sound because the trainee may not recognize whether the sound is loud or not as he/she hears only a pure sound.

A method for training absolute pitch which is based on hearing a compound tone in which the fundamental sound and the overtone are mixed is difficult for a trainee to recognize the fundamental sound during training However, if the trainee may recognize the fundamental sound, it can be determined whether he/she has focused on the fundamental sound since he/she also hears the overtone.

According to the present invention, a training method for sequentially hearing the overtone and the compound tone is proposed. As this method uses a subtle difference between the overtone and the compound tone, recognition of the fundamental sound is easier compared to hearing only the compound tone. When the focus is given according to the pitch of the recognized fundamental sound, it may be determined whether the focus has been given to the fundamental sound as there exist overtones. That is, according to the present invention, the overtone which obstructs the recognition of the fundamental sound is used to focus on the fundamental sound to thereby persons to have absolute pitch.

That is, the absolute pitch training apparatus 100 according to the exemplary embodiment of the present invention provides the compound tone in which the fundamental sound and the overtone are mixed, and the overtone to thereby a person to recognize the subtle change between the compound tone and the overtone and to recognize the fundamental sound more easily. Also, the absolute pitch training apparatus 100 according to the exemplary embodiment of the present invention enables a person to improve the ability to accurately identify and hear the fundamental sound and allows whether the focus is given to the fundamental sound.

To enable a trainee to accurately identify and hear the fundamental sound having the basic number of vibrations after hearing a general sound which is a sound in which the fundamental sound and the overtone are mixed, the absolute pitch training apparatus 100 according to the exemplary embodiment of the present invention provides first the overtone excluding the fundamental sound having the basic number of vibrations for a specific sound, followed by the compound tone in which the fundamental sound and the overtone are mixed. As the overtone and the compound tone are sequentially provided, a user may improve the ability to distinguish a subtle difference between the overtone and the compound tone. Such ability helps a user to improve the ability to accurately identify and hear the fundamental sound which means the difference between the overtone and the compound tone and concurrently helps to determine whether focus is given at which pitch.

The pitch which has been referred to above physically means the difference of the number of vibrations of sound. A user feels the pitch is high if the pitch has a larger number of vibrations with auditory stimulus, and feels the pitch is low if the pitch has a smaller number of vibrations.

In the absolute pitch training apparatus 100 according to the exemplary embodiment of the present invention, the overtone output unit 120 and the compound tone output unit 130 may output the overtone and the compound tone as tone of at least one musical instrument. The musical instrument may include at least one of piano, jazz piano, classic piano, guitar and violin.

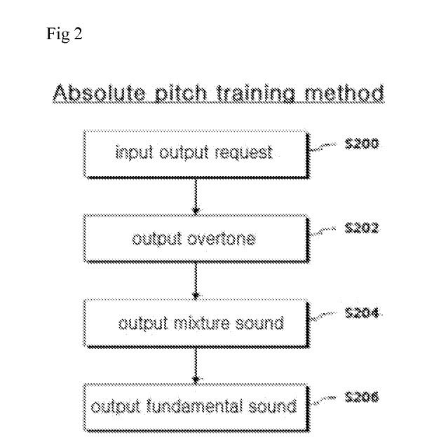

FIG. 2 is a flowchart of an absolute pitch training method according to another exemplary embodiment of the present invention.

Referring to FIG. 2, the absolute pitch training method according to the another exemplary embodiment of the present invention includes taking, as an input, an output request for a specific sound (S200); outputting the overtone for outputting the overtone having the greater number of vibrations than the basic number of vibrations for the specific sound (S202); and outputting a compound tone for outputting the compound tone in which a fundamental sound having the basic number of vibrations for a specific sound and an overtone having the greater number of vibrations than the basic number of vibrations for a specific sound are mixed (S204).

If a user who is being trained for an absolute pitch according to the another exemplary embodiment of the present invention hears the overtone at operation S202 at which the overtone is output, hears the compound tone at operation S204 at which the compound tone is output and recognizes the difference between the overtone and the compound tone, it is what a user recognizes the fundamental sound. To identify whether a user has accurately recognized the fundamental sound, as shown in FIG. 2, the absolute pitch training method according to the another exemplary embodiment of the present invention may further include outputting the fundamental sound (S206) for outputting the fundamental sound having the basic number of vibrations for a specific sound which has been requested to be output after certain time elapses or at the request of a user after the operation for outputting the compound tone (S204).

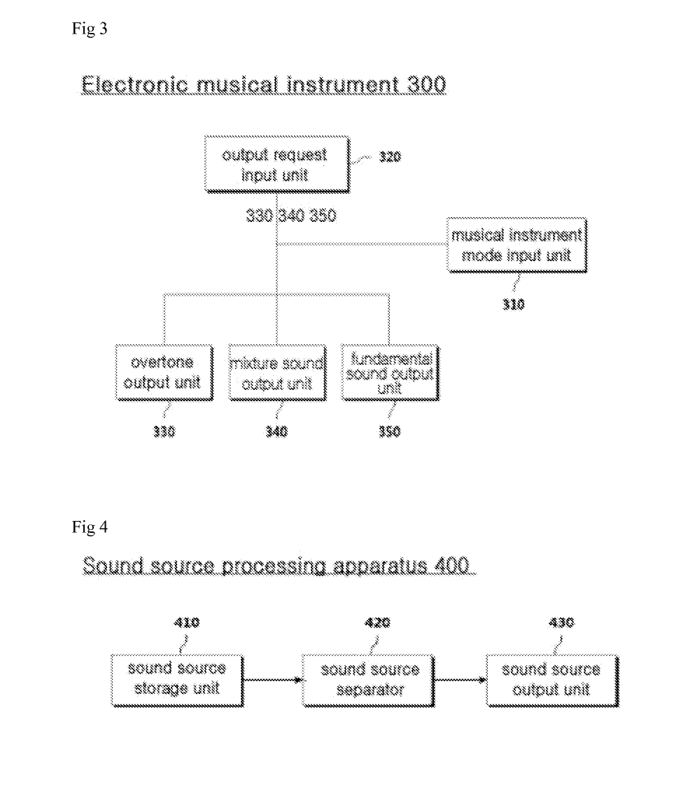

The absolute pitch training apparatus 100 as described above may be mounted in an electronic musical instrument to provide an electronic musical instrument such as a digital piano which is not only played but also provides the absolute pitch training function. The musical instrument providing the playing function and the absolute pitch training function will be described in more detail with reference to FIG. 3.

FIG. 3 is a block diagram of an electronic musical instrument 300 according to another exemplary embodiment of the present invention.

Referring to FIG. 3, the electronic musical instrument 300 according to another exemplary embodiment of the present invention includes a musical instrument mode input unit 310 which receives an input for a musical instrument mode for designating a specific musical instrument of at least one musical instrument by a user's manipulation; an output request input unit 320 for taking, as an input, an output request for a specific sound as a user presses a keyboard; an overtone output unit 330 for outputting an overtone having the greater number of vibrations than the basic number of vibrations for a specific sound as a tone of a specific musical instrument according to the input musical instrument mode; and a compound tone output unit 340 for outputting the compound tone in which a fundamental sound having the basic number of vibrations for a specific sound and an overtone having the greater number of vibrations than the basic number of vibrations are mixed, as a tone of a specific musical instrument according to the input musical instrument mode.

If a user who is being trained for an absolute pitch by the electronic musical instrument 300 providing the absolute pitch training function according to the another exemplary embodiment of the present invention hears an overtone through the overtone output unit 330, hears a compound tone through the compound tone output unit 340 and recognizes the difference between the overtone and the compound tone, it is what a user recognizes the fundamental sound. To identify whether a user has accurately recognized the fundamental sound, the electronic musical instrument 300 according to the another exemplary embodiment of the present invention may further include a fundamental sound output unit 350 for outputting a fundamental sound having the basic number of vibrations for a specific sound which has been requested to be output as a user presses a keyboard, as shown in FIG. 3.

The electronic musical instrument 300 according to the another exemplary embodiment of the present invention may suspend the operations of the overtone output unit 330 and the fundamental sound output unit 350 to output only the compound tone in which the fundamental sound and the overtone are mixed, as in a general electronic musical instrument, through the compound tone output unit 340.

The electronic musical instrument 300 according to the another exemplary embodiment of the present invention may suspend the operations of the overtone output unit 330 and the compound tone output unit 340 and output only the fundamental sound having the basic number of vibrations through the fundamental sound output unit 350. As only the fundamental sound is output and played, training for an absolute pitch may be confirmed after training for an absolute pitch focusing on the fundamental sound.

An absolute pitch may be trained through sound sources such as music files stored in computers, portable terminals and Karaoke devices. In this case, a sound source processing apparatus for processing the sound source stored in the computers, portable terminals and Karaoke devices may be mounted in such computers, portable terminals and Karaoke devices. The sound source processing apparatus will be described with reference to FIG. 4.

FIG. 4 is a block diagram of a sound source processing apparatus 400 according to another exemplary embodiment of the present invention.

Referring to FIG. 4, the sound source processing apparatus 400 according to another exemplary embodiment of the present invention includes the following:

a sound source storage unit 410 for storing therein a sound source; a sound source separator 420 for separating a fundamental sound having the basic number of vibrations and an overtone having the greater number of vibrations than the basic number of vibrations from the stored sound source; and a sound source output unit 430 for selectively or sequentially outputting at least one of the fundamental sound, overtone and compound tone (in which the fundamental sound and the overtone are mixed).

As described above, a method and an apparatus for training an absolute pitch 100 according to the exemplary embodiments of the present invention is provided for persons who study music, are engaged in musical work or wish to improve musicality to have an absolute pitch. Also, the electronic musical instrument 300 and the sound source processing apparatus 400 for providing the absolute pitch training function may be also provided.

Even though all of elements of the exemplary embodiments according to the present invention have been described as being coupled or as being coupled and operating as one element, the present invention is not limited to the exemplary embodiments. That is, to the extent of the purpose of the present invention, all of such elements may be selectively coupled and operate as one or more elements. Such elements may be realized as each individual hardware, but all or part of such elements may be selectively combined into a computer program having a program module performing partial or all functions combined by a single or a plurality of hardware. Codes and code segments forming the computer program may be easily inferred by a person of ordinary skill in the art of the present invention. Such computer program may be stored in computer readable media read by a computer, is read and executed by the computer to thereby realize the exemplary embodiments of the present invention. The computer readable media for the computer program may include magnetic recording media, optical recording media and carrier wave media.

Terms such as “include”, “form” or “have” as described above means that a concerned element may be inherent in the concerned element unless there is any statement specifically to the contrary. In this regard, such terms should be interpreted that the elements may further include other elements instead of excluding other elements. All terms including technical or scientific terms have the same meaning as generally understood by the person having the typical knowledge in the technical field to which the present invention belongs unless otherwise defined. Terms which are generally used as terms defined in dictionary should be interpreted as being consistent with the meaning in context of the relevant technology and will not be interpreted as idealistic or excessively formal meaning

Although a few exemplary embodiments have been shown and described, it will be appreciated by those skilled in the art that changes may be made in these exemplary embodiments without departing from the principles and spirit of the invention, the range of which is defined in the appended claims and their equivalents. Accordingly, the exemplary embodiments of the present invention are provided to explain the technical spirit of the present invention but not to limit such spirit. The scope of the technical spirit of the present invention is not limited by the exemplary embodiments of the present invention. The scope of protection of the present invention should be interpreted by the claims below, and all technical spirits which are in the same scope would be interpreted as being included in the scope of right of the present invention.

1. An absolute pitch training apparatus comprising: an output request input unit for taking, as an input, an output request for a specific sound; an overtone output unit for outputting an overtone, the number of vibrations of which is greater than the basic number of vibrations for the specific sound; and a compound tone output unit for outputting a compound tone in which a fundamental sound, having a basic number of vibrations, and an overtone for a specific sound are mixed.

2. The absolute pitch training apparatus according to claim 1, further comprising a fundamental sound output unit for outputting a fundamental sound having a basic number of vibrations for the specific sound.

3. The absolute pitch training apparatus according to claim 1, wherein the overtone output unit and the compound tone output unit output the overtone and the compound tone as a tone of at least one musical instrument.

4. An absolute pitch training method comprising: taking, as an input, an output request for a specific sound; outputting an overtone for outputting an overtone, the number of vibrations of which is greater than a basic number of vibrations for the specific sound; and outputting a compound tone for outputting a compound tone in which a fundamental sound having a basic number of vibrations and the overtone for the specific sound are mixed.

5. An electronic musical instrument comprising: a musical instrument mode input unit for receiving an input for a musical instrument mode for designating a specific musical instrument of at least one musical instrument; an output request input unit for taking, as an input, an output request for a specific sound; an overtone output unit for outputting an overtone the number of vibrations of which is greater than a basic number of vibrations for the specific sound as a tone of the specific musical instrument; and a compound tone output unit for outputting a compound tone in which a fundamental sound having a basic number of vibrations and the overtone for the specific sound are mixed, as a tone of the specific musical instrument.

6. A sound source processing apparatus comprising: a sound source storage unit for storing therein a sound source; a sound source separator for separating a fundamental sound having a basic number of vibrations and an overtone the number of vibrations of which is greater than the basic number of vibrations from the stored sound source; and a sound source output unit for outputting at least one of the fundamental sound, the overtone and the compound tone in which the fundamental sound and the overtone are mixed.
